(19) United States
(12) Patent Application Publication
(10) Pub. No.: US 2012/0114800 A1
(43) Pub. Date: May 10, 2012

(54) Drink Enhancer System

(75) Inventor: William D. McKay, Phoenix, AZ (US)

(73) Assignee: ECOSENTIALS, LLC, Phoenix, AZ (US)

(21) Appl. No.: 13/284,807

(22) Filed: Oct. 28, 2011

Related U.S. Application Data
(60) Provisional application No. 61/412,335, filed on Nov. 10, 2010.

(51) Int. Cl. B65D 47/20; A23L 1/304; A23L 2/60; A23L 1/302

(52) U.S. Cl. 426/72; 426/115; 222/212

(57) ABSTRACT

A drink enhancer system. A squeezable housing has two curved opposing sides and contains a drink enhancer configured to be mixed with a drink to create an enhanced drink. A dispensing cap removably couples to the squeezable housing and includes a valve which includes two intersecting linear slits in a flexible polymer member. The valve is exposed when the dispensing cap is in an open position and concealed when the dispensing cap is in a closed position. A flip-top portion of the dispensing cap is coupled to a base of the dispensing cap through a living hinge. The drink enhancer system dispenses a predetermined quantity of drink enhancer into a quantity of drink, in response to a squeeze of the squeezable housing, with sufficient velocity to agitate the quantity of drink sufficiently that the predetermined quantity of drink enhancer and quantity of drink sufficiently mix for drinking without further mixing.

### CROSS REFERENCE TO RELATED APPLICATIONS

This document claims the benefit of the filing date of U.S. Provisional Patent Application 61/412,335, entitled “Apparatus and method for dispensing and mixing water soluble concentrate ingredients with water without stirring” to William Douglas McKay, Sr. which was filed on Nov. 10, 2010, the disclosure of which is hereby incorporated entirely herein by reference.

### BACKGROUND

1. Technical Field

Aspects of this document relate generally to systems to enhance drinks More specific implementations involve systems to enhance water.

2. Background Art

Many different types of conventional beverages are available which are prepared using a wide variety of methods and systems. For example, soft drinks are prepared through the mixing of syrup with carbonated water as it passes through a soda fountain machine. Beverages such as orange juice may be prepared from squeezing oranges to directly produce juice which is pasteurized or may be prepared from concentrated orange juice which has been stored for a period of time before being mixed with water. Many sports drinks are prepared by mixing desired flavors and colors with water and bottling the created drink for consumption directly from the bottle.

### SUMMARY

Implementations of drink enhancer systems may include: a squeezable housing having two curved opposing sides; a drink enhancer contained within the squeezable housing, the drink enhancer configured to be mixed with a drink to create an enhanced drink; and a dispensing cap removably coupled to the squeezable housing; the dispensing cap having a valve therein, the valve having two intersecting linear slits in a flexible polymer member, the valve configured to be exposed when the dispensing cap is in an open position and configured to be concealed when the dispensing cap is in a closed position; and wherein a flip-top portion of the dispensing cap is coupled to a base of the dispensing cap through a living hinge; and wherein the drink enhancer system is configured to dispense a predetermined quantity of the drink enhancer into a quantity of the drink in response to a squeeze of the squeezable housing.

Implementations of drink enhancer systems may include one, all, or any of the following:

The drink enhancer system may be configured to dispense the predetermined quantity of the drink enhancer into the quantity of the drink with sufficient velocity to agitate the quantity of the drink sufficiently that the predetermined quantity of the drink enhancer and the quantity of the drink sufficiently mix for drinking without requiring further mixing by a user.

The squeezable housing may have a sidewall thickness between about 0.015 inches and about 0.030 inches.

The drink enhancer may have a viscosity between about 2 cP and about 350 cP.

The valve and drink enhancer may be configured to allow substantially all of the drink enhancer to rest above the valve without the drink enhancer leaking substantially through the valve.

The drink enhancer may include a pharmaceutically effective amount of an appetite control additive in the predetermined quantity of drink enhancer, the pharmaceutically effective amount configured to double the weight loss effect of 16 ounces of water drunk prior to a user eating a meal.

The squeezable housing may have an hourglass shape.

The drink enhancer system may be configured to dispense between about 0.1 fluid ounces and about 1.5 fluid ounces of the drink enhancer in response to one squeeze of the squeezable housing.

The drink enhancer may include one of a sweetened flavor enhancer and a sweetened, concentrated flavor enhancer.

The drink enhancer may include one of concentrated vitamins and concentrated minerals.

Implementations of drink enhancer systems may include: a squeezable housing having two curved opposing sides and having a sidewall thickness between about 0.015 inches and about 0.030 inches; a sweetened flavor enhancer contained within the squeezable housing, the sweetened flavor enhancer configured to be mixed with water to create a sweetened drink; and a dispensing cap removably coupled to the squeezable housing; the dispensing cap having a valve therein, the valve having two intersecting linear slits in a flexible polymer member, the valve configured to be exposed when the dispensing cap is in an open position and configured to be concealed when the dispensing cap is in a closed position; and wherein a flip-top portion of the dispensing cap is coupled to a base of the dispensing cap through a living hinge; and wherein the drink enhancer system is configured to dispense a predetermined quantity of the sweetened flavor enhancer into a quantity of water in response to a squeeze of the squeezable housing.

Implementations of drink enhancer systems may include one, all, or any of the following:

The drink enhancer system may be configured to dispense the predetermined quantity of sweetened flavor enhancer into the quantity of water with sufficient velocity to agitate the quantity of water sufficiently that the predetermined quantity of sweetened flavor enhancer and the quantity of water sufficiently mix for drinking without requiring further mixing by a user.

The sweetened flavor enhancer may have a viscosity between about 2 cP and about 350 cP.

The valve and the sweetened flavor enhancer may be configured to allow substantially all of the sweetened flavor enhancer to rest above the valve without the sweetened flavor enhancer leaking substantially through the valve.

The sweetened flavor enhancer include a pharmaceutically effective amount of an appetite control additive in the predetermined quantity of sweetened flavor enhancer, the pharmaceutically effective amount configured to double the weight loss effect of 16 ounces of water drunk prior to a user eating a meal.

The squeezable housing may include an hourglass shape.

The drink enhancer system may be configured to dispense between about 0.1 fluid ounces and about 1.5 fluid ounces of the sweetened flavor enhancer in response to one squeeze of the squeezable housing.

The sweetened flavor enhancer may include a sweetened, concentrated flavor enhancer.

The sweetened flavor enhancer may include one of concentrated vitamins and concentrated minerals.

Implementations of drink enhancer systems may include: a squeezable housing having two curved opposing sides and a sidewall thickness between about 0.015 inches and about 0.030 inches; a sweetened, concentrated flavor enhancer contained within the squeezable housing, the sweetened, concentrated flavor enhancer configured to be mixed with water to create a sweetened drink; the sweetened, concentrated flavor enhancer having a viscosity between about 2 cP and about 350 cP; and a dispensing cap removably coupled to the squeezable housing; the dispensing cap having a valve therein, the valve having two intersecting linear slits in a flexible polymer member, the valve configured to be exposed when the dispensing cap is in an open position and configured to be concealed when the dispensing cap is in a closed position; and wherein a flip-top portion of the dispensing cap is coupled to a base of the dispensing cap through a living hinge; wherein the drink enhancer system is configured to dispense a predetermined quantity of sweetened, concentrated flavor enhancer into a quantity of water, in response to one squeeze of the squeezable housing, with sufficient velocity to agitate the quantity of water sufficiently that the predetermined quantity of sweetened, concentrated flavor enhancer and quantity of water sufficiently mix for drinking without requiring further mixing by a user.

Implementations of drink enhancer systems may include one, all, or any of the following:

The valve and sweetened, concentrated flavor enhancer may be configured to allow substantially all of the sweetened, concentrated flavor enhancer to rest above the valve without the sweetened, concentrated flavor enhancer leaking substantially through the valve.

The sweetened, concentrated flavor enhancer may include a pharmaceutically effective amount of an appetite control additive in the predetermined quantity of sweetened, concentrated drink enhancer, the pharmaceutically effective amount configured to double the weight loss effect of 16 ounces of water drunk prior to a user eating a meal.

The drink enhancer system may be configured to dispense between about 0.1 fluid ounces and about 1.5 fluid ounces of the sweetened, concentrated flavor enhancer in response to one squeeze of the squeezable housing.

The foregoing and other aspects, features, and advantages will be apparent to those artisans of ordinary skill in the art from the DESCRIPTION and DRAWINGS, and from the CLAIMS.

### BRIEF DESCRIPTION OF THE DRAWINGS

Implementations will hereinafter be described in conjunction with the appended drawings, where like designations denote like elements, and:

FIG. 1 is a perspective view of a drink enhancer system;

FIG. 2 is a perspective view of a drink enhancer system in use; and

FIG. 3 is a top view of a dispensing cap of a drink enhancer system in an open position.

### DESCRIPTION

This disclosure, its aspects and implementations, are not limited to the specific components or assembly procedures disclosed herein. Many additional components and assembly procedures known in the art consistent with the intended drink enhancer systems and/or assembly procedures for drink enhancer systems will become apparent for use with particular implementations from this disclosure. Accordingly, for example, although particular implementations are disclosed, such implementations and implementing components may comprise any shape, size, style, type, model, version, measurement, concentration, material, quantity, and/or the like as is known in the art for such drink enhancer systems and implementing components, consistent with the intended operation.

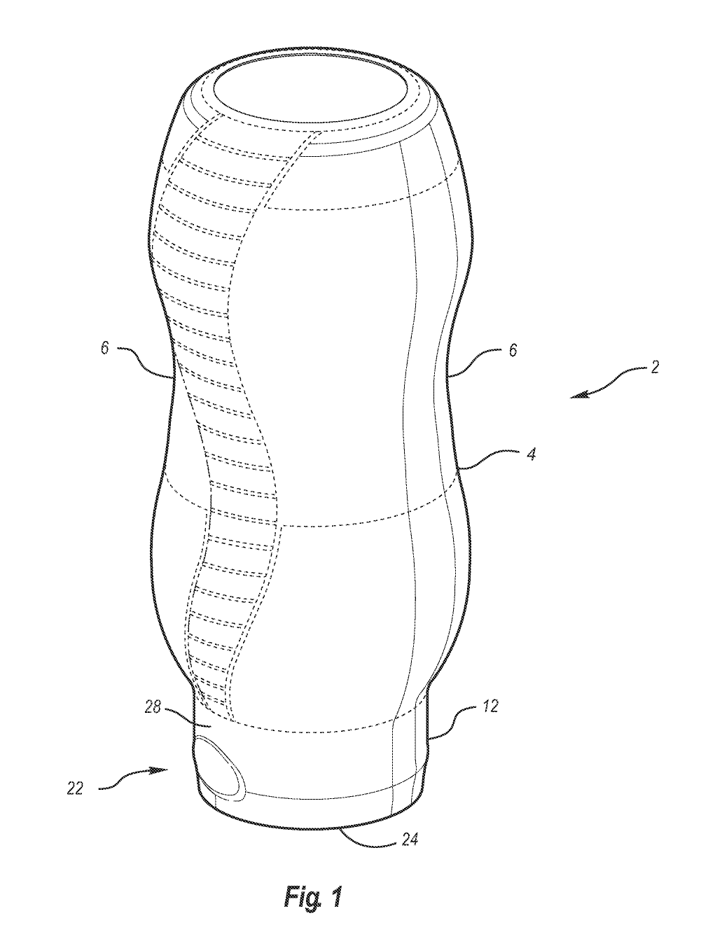

Referring now to FIGS. 1-3, in various implementations a drink enhancer system 2 includes a squeezable housing 4 which has two curved opposing sides 6. In the implementation illustrated in FIG. 1, the two curved opposing sides 6 curve inwardly toward the center of the squeezable housing 4. In other implementations, however, the two curved opposing sides 6 may curve outwardly away from the center of the squeezable housing 4. Contained within the squeezable housing 4 is a drink enhancer 8. The drink enhancer 8 contains various components which are adapted to be mixed with a drink 10 to create an enhanced drink. In various implementations, the drink enhancer 8 is a liquid included within the squeezable housing 4 as part of a bottling process; in other implementations, the drink enhancer 8 is created by including within the squeezable housing 4 a powder to which the user adds water or other liquid and mixes together, thereby creating the drink enhancer. In some implementations, the drink enhancer 8 could be prepared within the squeezable housing 4 by a user releasing a powder contained in one portion of the housing 4 into a liquid contained within another portion of the housing and mixing the powder with the liquid. Coupled to the squeezable housing 4 is a dispensing cap 12 having a base 28 and a flip-top portion 24. The flip-top portion 24 is coupled to the base 28 through a living hinge 26. The dispensing cap 12 includes a valve 14 which includes two intersecting linear slits 16 in a flexible polymer member 18. While in the implementation illustrated in FIG. 3, two perpendicularly intersecting linear slits 16 are used, a wide variety of other configurations, are possible, including by non-limiting example, two slits intersecting non-perpendicularly, more than two slits intersecting, three slits intersecting in a star shape, a single slit, or any other opening configured to allow the flexible polymer member 18 to retain fluids and express them under pressure applied to the squeezable housing 4. In the implementations shown the valve 14 is situated in the base 28. The valve 14 is exposed when the dispensing cap 12 is in an open position 20 and is concealed when the dispensing cap 12 is in a closed position 22.

The drink enhancer system 2 may be configured such that one squeeze of the squeezable housing 4 by a user dispenses a predetermined quantity of drink enhancer 8 into a quantity of drink 10. In various implementations, the predetermined quantity of drink enhancer 8 is dispensed with sufficient velocity to agitate the quantity of drink 10 receiving it sufficiently so that the predetermined quantity of drink enhancer 8 and quantity of drink 10 become mixed for drinking without requiring further mixing (such as, by non-limiting example, by stirring or shaking) by the user. The ability of the drink enhancer system 2 to dispense the predetermined quantity of drink enhancer 8 at the sufficient velocity to create the mixing effect may be referred to as “self-stirring” the predetermined quantity of drink enhancer 8 with the quantity of drink 10.

For the exemplary purposes of this disclosure, the squeezable housing 4 in implementations may be formed from a flexible polymer having a sidewall thickness between about 0.015 inches and about 0.030 inches. In various implementations the flexible polymer of the squeezable housing 4 may be, by non-limiting example, one or more of the following: polyethylene terephthalate (PETE) and/or high density polyethylene (HDPE), low density polyethylene (LDPE), polyvinyl chloride (PVC), polypropylene (PP), polystyrene (PS), post consumer resin (PCR), and the like. In specific implementations, the squeezable housing 4 may be formed of polyethylene terephthalate (PETE) and/or high density polyethylene (HDPE). The squeezable housing 4 may be formed, by non-limiting example, by one or a combination of the following: blow molding; extrusion blow molding; injection blow molding; stretch blow molding; pre form blow molding; and any other molding method capable of creating a hollow polymer bottle shape. In implementations the volume within the squeezable housing 4 in a squeezed state may be about 80% of the volume within the squeezable housing 4 in a non-squeezed state. In implementations the squeezable housing 4 may be sized to hold about 1 liter or 12 fluid ounces of drink enhancer 8 when in a non-squeezed state. In other implementations the squeezable housing 4 may be sized to hold between about 2 fluid ounces and about 5 fluid ounces of drink enhancer 8 when in a non-squeezed state.

The two curved opposing sides 6 in the implementations shown curve both inward relative to the center of the squeezable housing 4. It can be seen from FIG. 1, for example, that the effect of this curving inward relative to the center creates an hourglass shape in the squeezable housing 4. The narrower portion of the squeezable housing 4 located at the point where the two curved opposing sides are closest to the center of the squeezable housing may be one of, by non-limiting example, about 50% to about 95%, about 75% to about 85%, about 87%, or about 80% of the width of the wider upper or lower portions of the squeezable housing 4.

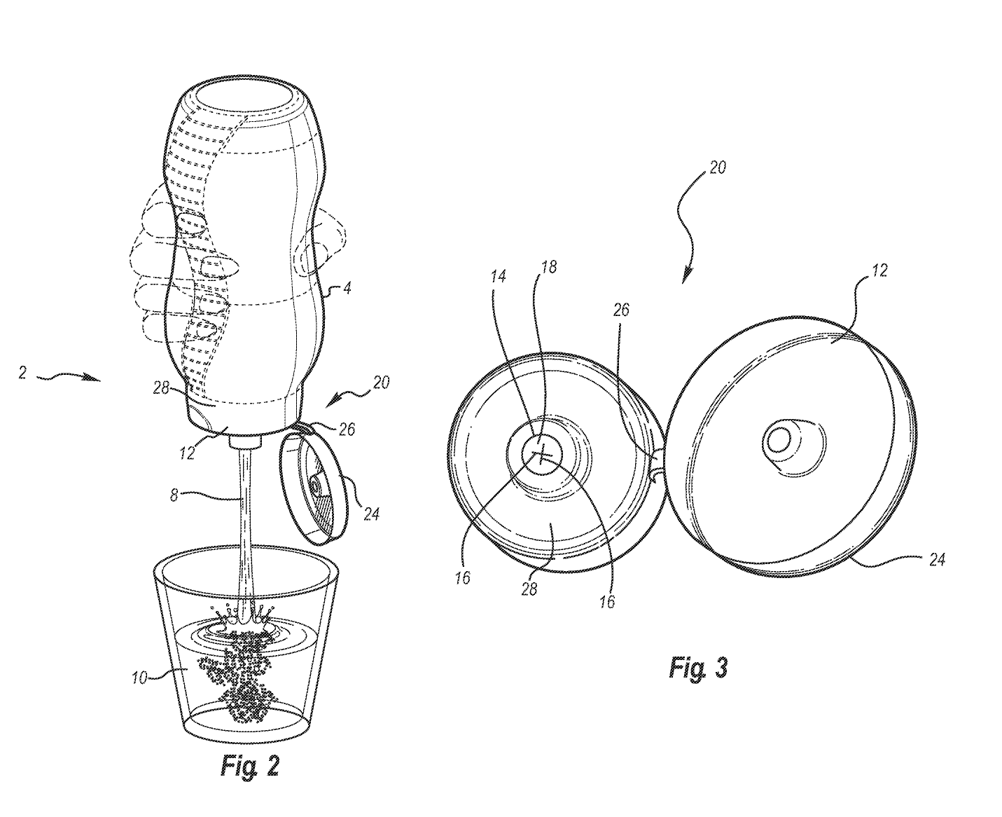

In various implementations the drink enhancer system 2 is configured to rest with the valve 14 below the drink enhancer 8, i.e., all or substantially all of the drink enhancer 8 rests above the valve 14, while the valve 14 maintains its closed position such that the drink enhancer 8 does not substantially leak out of the squeezable housing 4 through the valve 14. In such implementations, when the dispensing cap 12 is in a closed position 22, the drink enhancer system 2 may rest with the flip-top portion 24 of the dispensing cap 12 resting on a surface such as, by non-limiting example, a table, a floor, a shelf, and so forth. This is facilitated at least partly by the flat nature of the portion of the flip-top portion 24 that rests on the surface which supports the drink enhancer system 2. Additionally, in implementations the distal end of the drink enhancer system 2 furthest from the dispensing cap 12 may also have a substantially flat surface, as seen in FIGS. 1-2. Thus the drink enhancer system 2 may additionally rest with the end of the drink enhancer system 2 furthest from the dispensing cap 12 resting on a surface, such as a table, floor, shelf, and so forth. In such a configuration all or substantially all of the drink enhancer 8 resides below the dispensing cap 12 and below the valve 14. In other implementations, however, the dispensing cap 12 may be located so that the liquid does not contact the valve when the drink enhancer system 2 is resting on a surface (i.e., on the side opposite the surface).

The dispensing cap 12 may be any shape and include any desired function useful for dispensing the drink enhancer 8. In the implementations illustrated in FIGS. 1-3, the dispensing cap 12 is a cylindrical flip-top type of dispensing cap 12, wherein the dispensing cap 12 includes a base 28 and a flip-top portion 24 connected to the base 28 by a living hinge 26, and a valve 14 integrated into the base 28. When the dispensing cap 12 is in an open position 20, as in FIGS. 2-3, the valve 14 is exposed. When the dispensing cap 12 is in a closed position 22, as in FIG. 1, the valve 14 is concealed. The dispensing cap 12 may also have a protrusion in the inside face of the flip-top portion 24 which tends to prevent the valve 14 from opening when the dispensing cap 12 is in the closed position 22. The dispensing cap 12 may have a snap-shut mechanism by which the dispensing cap 12 tends to maintain in the closed position 22 with a friction fit or retaining member until a user applies sufficient force to overcome the friction fit or resistance of the retaining member. The living hinge 26 may be biased towards multiple configurations, for instance when an angle between the flip-top portion 24 and the base 28 is below a certain value the living hinge 26 may bias the dispensing cap 12 towards the closed position 22, and when an angle between the flip-top portion 24 and the base 28 is above a certain value the living hinge 26 may bias the dispensing cap 12 towards the open position 20.

In implementations the dispensing cap 12 is removably coupled to the squeezable housing 4. In particular implementations the dispensing cap 12 screws to the squeezable housing 4 using threads on the dispensing cap 12 and complementary threads on a neck of the squeezable housing 4, though in other implementations other coupling mechanisms may be used such as a snap or snap and twist mechanism. In implementations the dispensing cap 12 may be integrally formed with the squeezable housing 4. In such implementations the dispensing cap 12 would not be removably coupled to the squeezable housing 4.

In implementations the flexible polymer member 18 of the valve 14 is made of any of a wide variety of flexible polymers. In implementations the flexible polymer of the flexible polymer member 18 is silicone, though in other implementations other flexible polymers could be used. In implementations the flexible polymer member 18 is less than about 0.5 inches in diameter. In the implementations illustrated, the flexible polymer member 18 includes two linear slits 16 that intersect one another (though any of the other opening arrangements disclosed herein may also be used). In various implementations the linear slits 16 have a total combined length of between about 0.0005 inches and 0.5 inches. In various implementations, the valve 14 is designed such that it remains in a closed configuration, keeping the drink enhancer 8 within the squeezable housing 4 until a certain pressure level is reached within the squeezable housing 4 such as through squeezing the squeezable housing 4, which causes the valve 14 to open and the predetermined quantity of drink enhancer 8 to thus dispense from the squeezable housing 4. The result of this process is that, partly because the drink enhancer 8 does not dispense until a certain pressure is reached due to the characteristics of the valve 14, and partly due to the viscosity of the drink enhancer 8 (as discussed in the next paragraph), the drink enhancer 8 may dispense with a certain velocity greater than would be achieved if, for instance, the drink enhancer 8 were dispensed from a dropper. This velocity may be such that the drink 10 becomes self-stirred and is ready for consumption nearly immediately. In other implementations, through selection of the characteristics of the valve and/or the viscosity of the drink enhancer 8, the predetermined quantity of drink enhancer 8 may exit the valve in a dripping or slower velocity stream, which may require additional mixing of the drink 10 by the user before it is ready for consumption.

The drink enhancer system 2 may be configured to dispense a predetermined quantity of the drink enhancer 8 into a quantity of the drink 10 in response to a squeeze of the squeezable housing 4. By non-limiting example, in particular implementations, the drink enhancer system 2 may be configured to dispense from about 0.1 fluid ounces to about 1.5 fluid ounces of the drink enhancer 8 in response to one squeeze of the squeezable housing 4. The predetermined amount of drink enhancer 8 that may dispensed in response to one or more squeezes of the squeezable housing 4 is a function of the volume, shape, material, and/or flexibility of the squeezable housing 4, the characteristics of the valve 14, and the viscosity of the drink enhancer 8. By controlling these parameters, particularly controlling the thickness of the wall of the squeezable housing, the valve characteristics, and the viscosity of the drink enhancer, a desired amount can be dispensed with each squeeze. While this desired amount is referred to as predetermined, it must be understood that the desired amount will vary to some degree from squeeze to squeeze depending upon the amount of force actually applied by the user and potentially by the size of the user's hand.

As the drink enhancer 8 is dispensed, the volume within the squeezable housing 4 decreases. After the drink enhancer 8 is dispensed, the volume may increase to its pre-dispensing value through air entering the squeezable housing 4 through the valve 14. In particular implementations, however, the drink enhancer system 2 may have additional holes and/or valves to allow air to enter the squeezable housing 4 to return the volume of the squeezable housing 4 to its pre-dispensing value. Such additional valves may be one way or check valves.

In various implementations, the predetermined quantity of drink enhancer 8 dispensed in response to one squeeze of the squeezable housing 4 may be sufficient to enhance about 8 fluid ounces of the drink 10 such as, by non-limiting example, flavoring and sweetening 8 fluid ounces of water for drinking. In other implementations the predetermined quantity of drink enhancer 8 dispensed in response to one squeeze of the squeezable housing 4 may be enhance 16 fluid ounces or 20 fluid ounces of drink 10. The amount of drink 10 that may be enhanced by one squeeze may be determined by adjusting a concentration level of the various components of the drink enhancer 8 and/or by altering the predetermined quantity of drink enhancer 8 that is dispensed with one squeeze such as, by non-limiting example, by altering the size and/or squeeze characteristics of the squeezable housing 4, altering the valve 14 characteristics, altering the viscosity of the drink enhancer 8, or otherwise increasing the potency of the drink enhancer 8 or the volume of drink enhancer 8 dispensed with a single squeeze.

The fluid level of the drink enhancer 8 may be visible through the sidewall of the squeezable housing 4 and the squeezable housing 4 may include one or more visual indicators (seen in the dotted lines on the side of the squeezable housing 4 in FIG. 1) by which a user may visually ascertain how many predetermined quantities of drink enhancer 8 are still available for dispensing into a drink 10.

Various implementations of drink enhancer systems 2 may contain various implementations of drink enhancers 8 adapted to enhance some aspect of the drink 10. For example, in various implementations the drink enhancer 8 may include, by non-limiting example, one or more of the following: one or more vitamins, one or more minerals, one or more flavors, one or more sweeteners, one or more concentrated sweeteners, one or more colors, one or more concentrated vitamins, minerals, flavors, sweeteners, or colors, and any combination of the foregoing along with any other plant or animal extract or preparation desired. Thus, upon adding the drink enhancer 8 to the drink 10 one or more properties of the drink 10 is enhanced such as, by non-limiting example: the vitamin content of the drink 10, the mineral content of the drink 10, the flavor of the drink 10, the sweetness level of the drink 10, the color of the drink 10, the inclusion of bioactive compounds in the drink (such as caffeine, antioxidants, or plant or animal extracts) and so forth, thus creating an enhanced drink. The drink enhancer 8 combined with the drink 10 thus creates an enhanced drink. In implementations the drink enhancer 8 includes a sweetener and thus the drink enhancer 8 may be mixed with the drink 10 to create a sweetened drink. In implementations the drink enhancer 8 includes a sweetened flavor enhancer which alters the sweetness level and flavor of the drink 10. In implementations the sweetened flavor enhancer is in a concentrated form and thus is a sweetened, concentrated flavor enhancer. In implementations the drink enhancer 8 includes one or more flavors, one or more colors, one or more sweeteners, one or more vitamins, and one or more minerals.

In implementations in which the drink enhancer 8 includes one or more sweeteners the one or more sweeteners may include, by non-limiting example, one or more of the following: sugar, sucrose, lactose, fructose, glucose, high fructose corn syrup, saccharose, sugar substitute, stevia, aspartame, cyclamate, sucralose, neotame, acesulfame potassium, saccharin, sugar alcohol, brazzein, curculin, erythritol, glycyrrhizin, glycerol, hydrogenated starch hydrolysates, inulin, isomalt, lactitol, luo han guo, mabinlin, maltitol, malto-oligosaccharide, mannitol, miraculin, monatin, osladin, pentadin, sorbitol, tagatose, thaumatin, xylitol, ALITAME, ACLAME, salt of aspartame-acesulfame, sodium cyclamate, dulcin, sucrol, valzin, glucin, neohesperidin dihydrochalcone (NHDC), P-4000, E955, SPLENDA, SUKRANA, SUCRAPLUS, CANDYS, CUKREN, NEVELLA, and any other natural or synthetic sweetener. In some implementations the drink enhancer 8 is a liquid, though in other implementations the drink enhancer 8 could be a solid such as, by non-limiting example, a powder.

In particular implementations, the drink enhancer 8 may include an appetite reducer, an appetite suppressant, and/or an appetite satiate (“appetite control additive”). While a wide variety of appetite control additive compounds may be utilized, in particular implementations compounds derived from the Amorphophallus konjac plant may be utilized. An example of various compounds that could be utilized and additional disclosure regarding Amorphophallus konjac extracts may be found in U.S. Patent Application Publication No. 20100098826 to Shimizu et al., entitled “Polysaccharide Thickener-Containing Dietary Fiber Composition,” filed in the U.S. on Mar. 31, 2009, the disclosure of which is incorporated entirely herein by reference.

An example of such an appetite control additive may be the fiber-containing product marketed under the tradename LURALEAN by AHD International, LLC of Atlanta, Ga. Specific implementations of fiber-containing appetite control additives may include those (like LURALEAN) clinically tested to demonstrate that the consumption of about 1000 mg of the fiber-containing appetite control additive either individually or in food or drink was effective to promote weight loss and is a pharmaceutically effective amount. As has also been clinically demonstrated, the drinking of 16 ounces of water before eating is also effective for promoting weight loss. In particular implementations of drink enhancers 8 like those disclosed herein that contain fiber-containing appetite control additives, the addition of the drink enhancer containing a pharmaceutically effective amount of such an additive to 16 ounces of water drunk before eating may result in a doubling of the weight loss effect of either the 16 ounces of water or the appetite control additive used alone.

Accordingly, such implementations of drink enhancers 8 may be included in a method of weight loss including providing a drink enhancer 8 including an appetite control additive, adding a predetermined quantity of drink enhancer 8 containing a pharmaceutically effective amount of the appetite control additive to 16 ounces of water to create an enhanced beverage, and consuming the enhanced beverage prior to eating a meal. In specific implementations of the method, more than one predetermined quantity of drink enhancer 8 may be added to the 16 ounces of water, depending upon the concentration of the appetite control additive within the drink enhancer. For example, where the predetermined quantity of drink enhancer 8 is 0.5 ounces per squeeze, the concentration of the appetite control additive may require the user to make two squeezes in order to dispense sufficient drink enhancer into the 16 ounces of water to reach the desired concentration. Where the appetite control additive is LURALEAN, 500 mg of LURALEAN may be included in each 0.5 ounce predetermined volume of drink enhancer (or squirt or drink enhancer). Because of the effect a fiber-containing appetite control additive may have on the viscosity of the drink enhancer 8, there may be a critical concentration of the additive above which the viscosity of the drink enhancer is no longer able to be dispensed through the valve and still generate a self-stirring effect.

Implementations of drink enhancers 8 that include fiber-containing appetite control additives may provide additional health benefits and/or interactions with the other vitamins, minerals, and or plant or animal extracts contained in the drink enhancer 8 implementations. For example, the addition of the fiber may slow the movement of the drink enhancer through the gut of the person consuming the drink enhancer, providing additional time for absorption of the vitamins, minerals, and other extracts by the intestines. The inclusion of additional fiber may also provide other health benefits associated with consuming dietary fiber, including increased bowel regularity and reduction in cholesterol levels. Implementations of drink enhancers 8 that include appetite control additives may be any disclosed in this document.

The drink 10 may be any fluid able to be consumed by humans or animals including, by non-limiting example, any one or any combination of the following: water, any alcoholic beverage, any non-alcoholic beverage, any soft drink, carbonated water, milk, any liquid milk product, any fruit juice, any vegetable juice, any hot beverage, coffee or any coffee derivative or related drink, any tea, and the like. In various implementations the drink 10 is water.

The viscosity of the drink enhancer 8 at least partly facilitates the mixing mechanism. The viscosity of the drink enhancer 8 may be between about 2 cP and about 350 cP at 25 C, though viscosities of up to 500 cP to 750 cP may also be used. Particular implementations of drink enhancers 8 may have viscosities between about 2 cP and about 100 cP at 25 C. In various implementations, the viscosity of the fluid may impact the ability of the fluid when dispense to self-stir within the drink. However, in other implementations, the characteristics of the valve used may more significantly control the ultimate velocity of the fluid than the viscosity of the fluid. Accordingly, for a valve with a particular characteristic, a drink enhancer 8 with a viscosity over about 350 cP may not be able to dispense with sufficient velocity and/or the drink enhancer 8 would not have the mobility, once dispensed, to create a self-stirring effect as described herein. Within the range, however, for a given valve characteristic, the drink enhancer 8 may exit with the velocity needed to create the self-stirring effect. While implementations of drink enhancers at various viscosities have been discussed in the context of creating a self-stirring effect, it is important to note that for a valve with a characteristic designed to create a dripping effect, drink enhancer implementations within the range of about 2 cP to about 100 cP may create a dripping effect from the valve in response to a squeeze rather than exit as a stream with a velocity. Accordingly, various implementations of drink enhancer systems constructed using the principles disclosed herein may create either a self-stirring effect or a dripping effect depending upon the valve implementation included for a drink enhancer of a given viscosity within the ranges disclosed herein.

Referring to Table 1, various implementations of drink enhancers with specific brix, pH values, and viscosities are illustrated. In the implementations listed in Table 1, the degrees brix value is measured through use of refractive index, and the viscosity values correspond with measurements taken using a DV-I Prime (LVDV-IP) viscometer manufactured by Brookfield Engineering Laboratories, Inc. of Middleboro, Mass. measured using Spindle #4 (LV-4) at 10 rpm at 25 C.

TABLE 1

| Implementation | Brix (° Bx) | pH | Viscosity (cP) |
|---|---|---|---|
| #1 | 6.6 ± 0.6 | 2.3 ± 0.2 | 280 ± 10 |
| #2 | 8.9 ± 0.6 | 2.3 ± 0.2 | 120 ± 10 |
| #3 | 8.7 ± 0.6 | 2.3 ± 0.2 | 120 ± 10 |
| #4 | 10.6 ± 0.6 | 2.3 ± 0.2 | 120 ± 10 |
| #5 | 5.9 ± 0.6 | 2.6 ± 0.2 | 280 ± 10 |
| #6 | 9.2 ± 0.6 | 2.6 ± 0.2 | 120 ± 10 |
| #7 | 5.7 ± 0.6 | 2.3 ± 0.2 | 280 ± 10 |
| #8 | 5.3 ± 0.6 | 2.3 ± 0.2 | 280 ± 10 |

In places where the description above refers to particular implementations of drink enhancer systems, it should be readily apparent that a number of modifications may be made without departing from the spirit thereof and that these implementations may be applied to other drink enhancer systems.

1. A drink enhancer system, comprising:
a squeezable housing having two curved opposing sides;
a drink enhancer contained within the squeezable housing, the drink enhancer configured to be mixed with a drink to create an enhanced drink; and
a dispensing cap removably coupled to the squeezable housing; the dispensing cap comprising a valve therein, the valve comprising two intersecting linear slits in a flexible polymer member, the valve configured to be exposed when the dispensing cap is in an open position and configured to be concealed when the dispensing cap is in a closed position and wherein a flip-top portion of the dispensing cap is coupled to a base of the dispensing cap through a living hinge; and
wherein the drink enhancer system is configured to dispense a predetermined quantity of the drink enhancer into a quantity of the drink in response to a squeeze of the squeezable housing.

2. The drink enhancer system of claim 1, wherein the drink enhancer system is configured to dispense the predetermined quantity of the drink enhancer into the quantity of the drink with sufficient velocity to agitate the quantity of the drink sufficiently that the predetermined quantity of the drink enhancer and the quantity of the drink sufficiently mix for drinking without requiring further mixing by a user.

3. The drink enhancer system of claim 1, wherein the squeezable housing has a sidewall thickness between about 0.015 inches and about 0.030 inches.

4. The drink enhancer system of claim 1, wherein the drink enhancer has a viscosity between about 2 cP and about 100 cP at 25 C.

5. The drink enhancer system of claim 1, wherein the drink enhancer comprises a pharmaceutically effective amount of an appetite control additive in the predetermined quantity of drink enhancer, the pharmaceutically effective amount configured to double the weight loss effect of 16 ounces of water drunk prior to a user eating a meal.

6. The drink enhancer system of claim 1, wherein the squeezable housing comprises an hourglass shape.

7. The drink enhancer system of claim 1, wherein the drink enhancer system is configured to dispense between about 0.1 fluid ounces and about 1.5 fluid ounces of the drink enhancer in response to one squeeze of the squeezable housing.

8. The drink enhancer system of claim 1, wherein the drink enhancer comprises one of a sweetened flavor enhancer and a sweetened, concentrated flavor enhancer.

9. The drink enhancer system of claim 1, wherein the drink enhancer comprises one of concentrated vitamins and concentrated minerals.

10. A drink enhancer system, comprising:
a squeezable housing having two curved opposing sides and having a sidewall thickness between about 0.015 inches and about 0.030 inches;
a sweetened flavor enhancer contained within the squeezable housing, the sweetened flavor enhancer configured to be mixed with water to create a sweetened drink; and
a dispensing cap removably coupled to the squeezable housing; the dispensing cap comprising a valve therein, the valve comprising two intersecting linear slits in a flexible polymer member, the valve configured to be exposed when the dispensing cap is in an open position and configured to be concealed when the dispensing cap is in a closed position; and wherein a flip-top portion of the dispensing cap is coupled to a base of the dispensing cap through a living hinge; and
wherein the drink enhancer system is configured to dispense a predetermined quantity of the sweetened flavor enhancer into a quantity of water in response to a squeeze of the squeezable housing.

11. The drink enhancer system of claim 10, wherein the drink enhancer system is configured to dispense the predetermined quantity of sweetened flavor enhancer into the quantity of water with sufficient velocity to agitate the quantity of water sufficiently that the predetermined quantity of sweetened flavor enhancer and the quantity of water sufficiently mix for drinking without requiring further mixing by a user.

12. The drink enhancer system of claim 10, wherein the sweetened flavor enhancer has a viscosity between about 2 cP and about 350 cP at 25 C.

13. The drink enhancer system of claim 10, wherein the sweetened flavor enhancer comprises a pharmaceutically effective amount of an appetite control additive in the predetermined quantity of sweetened flavor enhancer, the pharmaceutically effective amount configured to double the weight loss effect of 16 ounces of water drunk prior to a user eating a meal.

14. The drink enhancer system of claim 10, wherein the squeezable housing comprises an hourglass shape.

15. The drink enhancer system of claim 10, wherein the drink enhancer system is configured to dispense between about 0.1 fluid ounces and about 1.5 fluid ounces of the sweetened flavor enhancer in response to one squeeze of the squeezable housing.

16. The drink enhancer system of claim 10, wherein the sweetened flavor enhancer comprises a sweetened, concentrated flavor enhancer.

17. The drink enhancer system of claim 10, wherein the sweetened flavor enhancer comprises one of concentrated vitamins and concentrated minerals.

18. A drink enhancer system, comprising:
a squeezable housing having two curved opposing sides and a sidewall thickness between about 0.015 inches and about 0.030 inches;
a sweetened, concentrated flavor enhancer contained within the squeezable housing, the sweetened, concentrated flavor enhancer configured to be mixed with water to create a sweetened drink; the sweetened, concentrated flavor enhancer comprising a viscosity between about 2 cP at 25 C and about 350 cP at 25 C; and
a dispensing cap removably coupled to the squeezable housing; the dispensing cap comprising a valve therein, the valve comprising two intersecting linear slits in a flexible polymer member, the valve configured to be exposed when the dispensing cap is in an open position and configured to be concealed when the dispensing cap is in a closed position; and wherein a flip-top portion of the dispensing cap is coupled to a base of the dispensing cap through a living hinge;
wherein the drink enhancer system is configured to dispense a predetermined quantity of sweetened, concentrated flavor enhancer into a quantity of water, in response to one squeeze of the squeezable housing, with sufficient velocity to agitate the quantity of water sufficiently that the predetermined quantity of sweetened, concentrated flavor enhancer and quantity of water sufficiently mix for drinking without requiring further mixing by a user.

19. The drink enhancer system of claim 17, wherein the sweetened, concentrated flavor enhancer comprises a pharmaceutically effective amount of an appetite control additive in the predetermined quantity of sweetened, concentrated flavor enhancer, the pharmaceutically effective amount configured to double the weight loss effect of 16 ounces of water drunk prior to a user eating a meal.

20. The drink enhancer system of claim 17, wherein the drink enhancer system is configured to dispense between about 0.1 fluid ounces and about 1.5 fluid ounces of the sweetened, concentrated flavor enhancer in response to one squeeze of the squeezable housing.
